(19) United States
(12) Patent Application Publication
(10) Pub. No.: US 2012/0072828 A1
(43) Pub. Date: Mar. 22, 2012

(54) COMPLEX INPUT TO IMAGE TRANSFORMATION FOR DISTRIBUTION

(75) Inventors: Brent M. Barkman, Ottawa (CA); Matthew Campbell, Markham (CA); John Mourra, Markham (CA); Lee Rosen, Toronto (CA); Sanjeev K. Sharma, Markham (CA)

(73) Assignee: INTERNATIONAL BUSINESS MACHINES CORPORATION, Armonk, NY (US)

(21) Appl. No.: 13/233,130

(22) Filed: Sep. 15, 2011

(30) Foreign Application Priority Data
Sep. 16, 2010 (CA) 2714228

(51) Int. Cl. G06F 17/00

(52) U.S. Cl. 715/234

(57) ABSTRACT

A method, system and computer program product for generating an image representing a page portion. A complex input is received to form a received input. The received input is rendered by a server based rendering engine absent a browser to create a rendered virtual page. The elements of the virtual page are identified to form identified elements. Each identified element is translated into an equivalent scalable vector graphic element. An image is generated using the equivalent scalable vector elements to form a generated image. And the generated image is stored.

### CROSS-REFERENCE TO RELATED APPLICATIONS

This application claims priority under 35 U.S.C. §119(a) from Canadian Patent Application No. 2714228, filed on Sep. 16, 2010, the contents of which are incorporated herein by reference.

### TECHNICAL FIELD

The present invention relates to the distribution of complex input formats in a data processing system, and more particularly, to transformation of complex input formats into a selected image format for distribution in an email service.

### BACKGROUND

In a current web-based environment, there is often a need for combining business related information into a readily usable format for transmission to a client. The combined business information may be a collection of embedded complex JavaScript™ and hypertext markup language pages, subsections of pages, or widgets implemented via hypertext markup language and JavaScript™. Given a limitation of most email clients to display complex hypertext markup language with cascading style sheets (CSS), and the security requirements of email clients when rendering JavaScript™, sending a complex format of input material presents a challenge.

One approach is to use scalable vector graphics (SVG). A drawback of this approach lies in the non-standardized and not widely distributed implementations of the SVG standard. Based on a rendering engine used to view SVG extensible markup language (XML) output, certain styles may appear differently.

One solution to the problem of rendering all or part of a hypertext markup language page into an email is to use a web rendering engine to generate a web page and capture a screenshot of the displayed page to produce an image. However, this approach requires that the page be displayed on the machine performing the rendering, which is typically not desirable for a server where hundreds of pages may be rendered every minute.

Another approach creates SVG output from the complex input and sends the SVG output to an SVG capable browser on the client. This approach converts complex input into an SVG output that must be processed on the client. However, this approach does not accommodate the use of the email client as desired and requires an SVG capable browser on a receiving client. Further, as mentioned previously, differing implementations of SVG browsers render output differently.

Hence, there is currently not an approach for combining business related information into a readily usable format for transmission to a client, wherein the format maintains integrity of representation across clients.

### BRIEF SUMMARY

In one embodiment of the present invention, a method for generating an image representing a page portion comprises receiving a complex input to form a received input. The method further comprises rendering the received input by a server based rendering engine to create a rendered virtual page. Additionally, the method comprises identifying elements of the virtual page to form identified elements. Furthermore, the method comprises translating each identified element into an equivalent scalable vector graphic element. In addition, the method comprises generating an image using the equivalent scalable vector elements to form a generated image. The method further comprises storing, by a processor, the generated image.

Other forms of the embodiment of the method described above are in a computer program product and in a system.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 is a block diagram of an exemplary network of data processing systems operable for various embodiments of the disclosure;

FIG. 2 is a block diagram of a data processing system operable for various embodiments of the disclosure;

FIG. 3 is a block diagram of a page portion processing system in accordance with one embodiment of the disclosure;

FIG. 4 is a block diagram of a process used in the page portion processing system of FIG. 3 in accordance with one embodiment of the disclosure; and

FIG. 5 is a flowchart of a process used in the page portion processing system of FIG. 3 in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

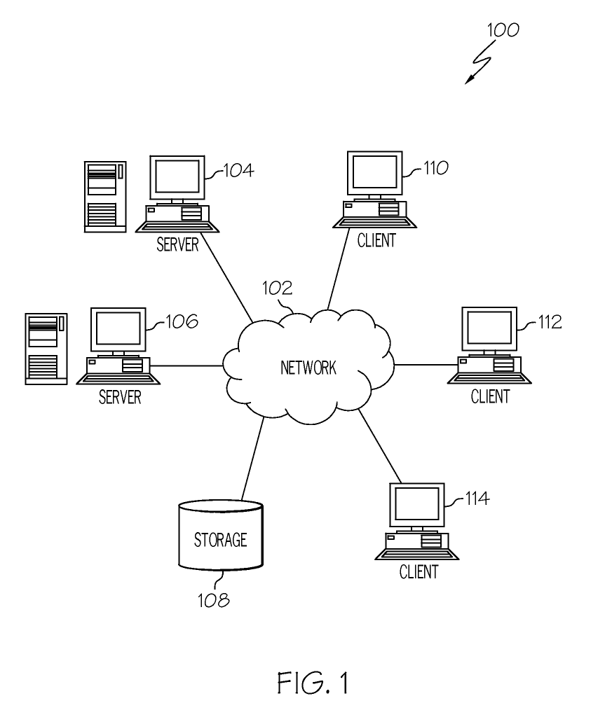

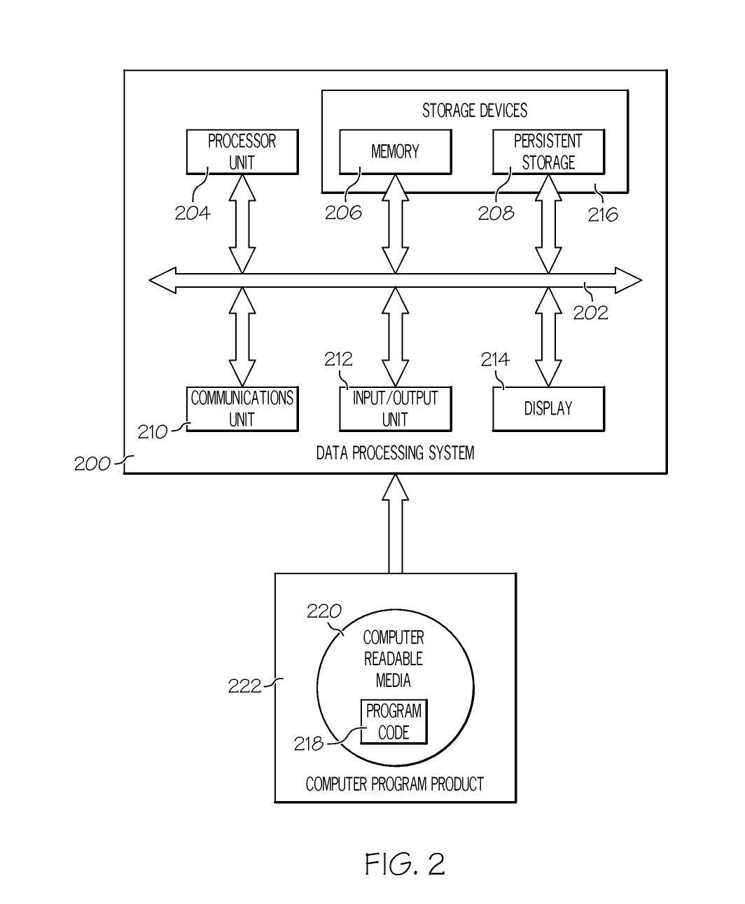

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Turning now to FIG. 2, FIG. 2 is a block diagram of an exemplary data processing system operable for various embodiments of the disclosure. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

According to an illustrative embodiment using data processing system 200 of FIG. 2 as an example of server 104 of a network of data processing systems 100 of FIG. 1, processor unit 204 executes a computer-implemented process for generating an image representing a page portion. Processor unit 204 receives a complex input to form a received input from communication unit 210, input/output unit 212 or storage devices 216 and renders the received input by a server based rendering engine to create a rendered virtual page and identifies elements of the virtual page to form identified elements. Processor unit 204 further translates each identified element into an equivalent scalable vector graphic element, generates an image using the equivalent scalable vector element to form a generated image and stores the generated image in storage devices 216. The generated image may be used by other processes on data processing 200 or transmitted to a client, such as client 114, through network 102 of FIG. 1.

In an alternative embodiment, program code 218 containing the computer-implemented process may be stored within computer readable media 220 as computer program product 222. In another illustrative embodiment, the process for generating an image representing a page portion may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process.

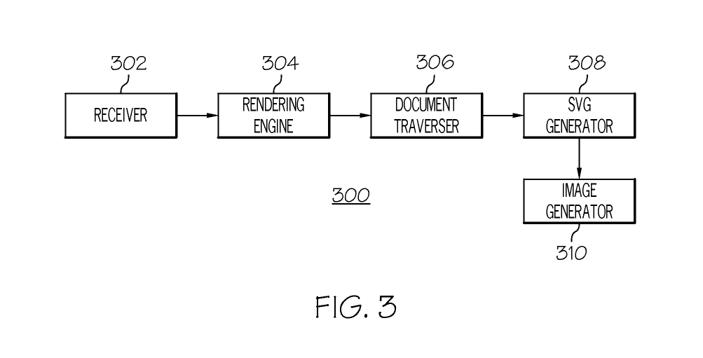

With reference to FIG. 3, a block diagram of a page portion processing system, in accordance with one embodiment of the disclosure is presented. Page portion processing system 300 is an example of a data processing system that provides a capability to transform a complex input source into a selected image for distribution with a system such as an email distribution system.

Page portion processing system 300 comprises a number of components specific to a transform of a complex input source into a selected image for distribution and in supporting the processing system. Components include receiver 302, rendering engine 304, document traverser 306, scalable vector graphics (SVG) generator 308 and image generator 310. Other components typically found in a data processing system provide support for the page portion processing system 300 and are not described further.

Receiver 302 provides a capability to receive input in a complex format. A complex format in this example comprises a set of input that may contain one or more various formats of input type. Input types are typically selected from a group of types including hypertext markup language, JavaScript™, XML, CSS, and SVG.

Rendering engine 304 provides a capability to render the input provided as complex input into a rendered document object model. Rendering engine 304 is typically provided in the form of a platform neutral implementation using a virtual machine base. The rendering engine may comprise selectable plug-ins to support various specific formats within the complex format input source. Rendering engine 304 provides a server side rendering service obviating a need for a client based rendering service. Further, when rendering the received complex input, rendering engine 304 does not initiate a browser environment for each process request, as in the example of a web browser being initiated on a client system. Rendering engine 304 produces a document object model from the processed complex input source received.

Document traverser 306 provides a capability to walk through the document object model created by rendering engine 304. The tree structure of the document object model in one exemplary embodiment is traversed using a JavaScript™ set of instructions. Each element of the document object model traversed is translated into a representation of a corresponding scalable vector graphic element by document traverser 306.

SVG generator 308 provides a capability to process intermediate output of document traverser 306. The intermediate output is a stream of SVG drawing orders.

Image generator 310 provides a capability to selectively request a specific type of image as an output format for the SVG drawing orders.

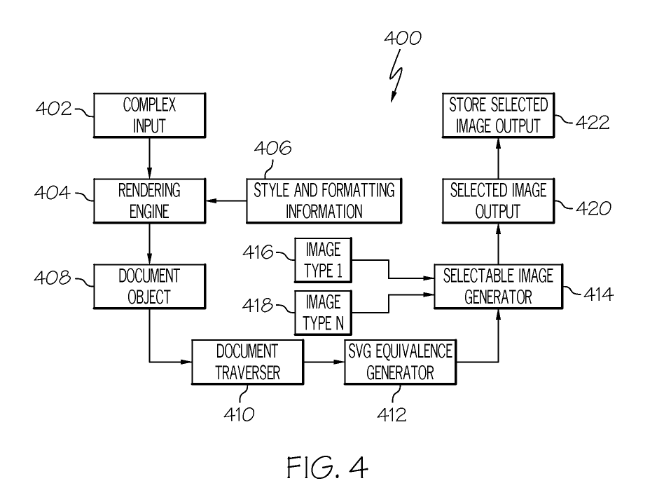

With reference to FIG. 4, a block diagram of a process used in the page portion processing system of FIG. 3, in accordance with one embodiment of the disclosure is presented. Process 400 is an example of a data flow of a page portion process in accordance with page portion processing system 300 of FIG. 3.

Complex input 402 is received from a requester. The requester may be another application on the same system as the page portion process or a different system or a user on a client data processing system. Complex input 402 contains a set of one or more types of input source data, substantive and format related, typically used to create information content of a web page.

Rendering engine 404 processes the received complex input 402 using style and formatting information 406. Style and formatting information 406 comprises information contained within complex input 402 or referenced by complex information 402. The output produced by rendering engine 404 is document object 408. Document object 408 is typically a document object model generated in a memory to form a data structure containing elements that define and describe the document or web page of interest. In one illustrative embodiment, the document object is in the form of a tree data structure defining a set of extensible markup language nodes.

Document traverser 410 walks through the data, such as the tree, processing each branch and leaf of associated nodes as needed. The output created by traversing the document object is input for SVG equivalence generator 412. SVG generator 412 provides input to selectable image generator 414. Selectable image generator 414 provides a capability to support a number of predefined image types depicted as image type 1 416 through image type N 418 to create selected image output 420. Store selected image output 422 saves the generated image for subsequent use by a user or another application, such as an email distribution.

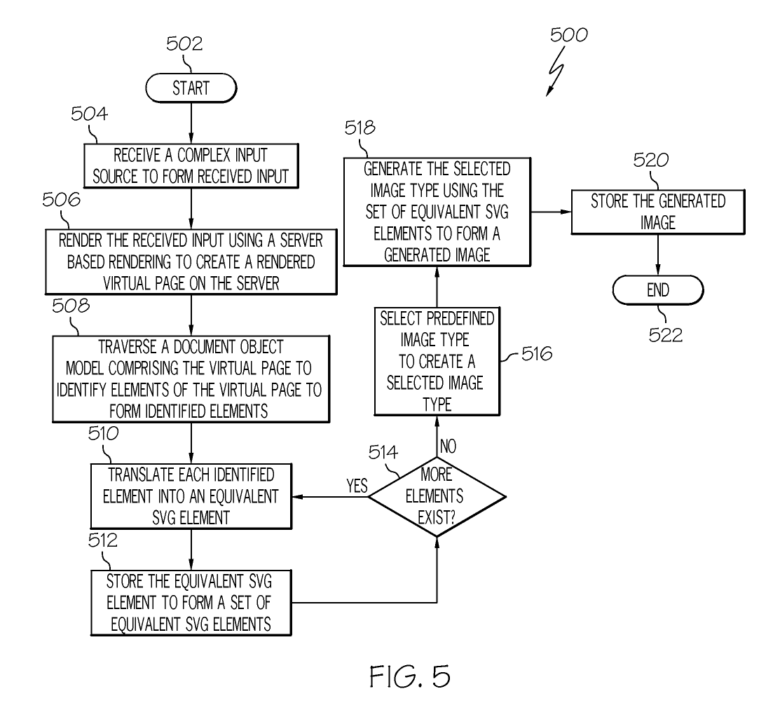

With reference to FIG. 5, a flowchart of a process used in the page portion processing system of FIG. 3, in accordance with one embodiment of the disclosure is presented. Process 500 is an example of a page portion process in accordance with page portion processing system 300 of FIG. 3.

Process 500 begins (step 502) and receives a complex input source to form a received input (step 504). The complex input source comprises a set of source formats of varying types including hypertext markup language, extensible markup language, JavaScript™ and other formats describing elements of the source.

Process 500 renders the received input using a server based rendering to create a rendered virtual page on the server (step 506). The virtual page is not displayed to a user but is materialized as a document object. The rendering process includes applying cascading style sheet information or in-line style information to the received input.

In one embodiment, the virtual page traversed is a rendered hypertext markup language document object model. Process 500 traverses the document object model comprising the virtual page to identify elements of the virtual page (step 508). Process 500 traverses the virtual page in the exemplary embodiment using JavaScript™, and translates each identified element to an equivalent scalable vector graphic (SVG) element (step 510). Process 500 stores the equivalent SVG element to form a set of equivalent SVG elements (step 512).

For example, each hypertext markup language element is processed by first determining absolute coordinates of the element on the page and also dimensions including a width and height of the element. The element is rendered after cascading style sheets and in-line styles have been applied, style values are retrieved and a respective equivalent SVG element is created with the coordinates, dimensions and applicable style information.

All SVG elements are absolutely positioned and given fixed width and height measurements. Not all hypertext markup language elements need to be absolutely positioned, but can be relative to other elements on the page, so each element is calculated using the offsetWidth and offsetHeight properties for each element. A width and height of an element are equal to an offsetWidth and offsetHeight of the element. An x and y coordinate location is calculated by traversing an offsetWidth and offsetHeight of a parent of the element until a top level element in the hypertext markup language document object model structure is reached.

SVG supports a subset of cascading style sheet styles supported in hypertext markup language that can be mapped directly. The supported styles include:

? Display, ? Visibility, ? Overflow, ? Unicode-bidi, ? Word-Spacing, ? Text-Decoration, ? Direction, ? Clip, ? Color, ? Letter-Spacing, ? Font-Style, ? Font-Variant, ? Font-Family, ? Font-Size, ? Font-Weight, and ? Font.

SVG only needs a subset of the hypertext markup language supported cascading style sheet styles because the style sheet information is captured through the calculation of the aforementioned values. In the case of a positional item, information is gathered by finding the location of the hypertext markup language element on the page.

SVG has no notion of borders on elements, therefore, the border cascading style sheet styles map to SVG line elements. The location of the line is calculated through the same method as determining the location of hypertext markup language elements on a page. The color, thickness and decoration of the border is calculated and applied to the SVG line.

Hypertext markup language form elements, such as buttons and check boxes, are arbitrarily defined with SVG elements to give a visual representation. For example, a check box in SVG is represented using an SVG square shape drawn for it. A button is represented as an SVG Rectangle shape, when the button does not contain a background image. When the button contains a background image, an SVG image is drawn.

Hypertext markup language lists are positioned correctly by calculating hypertext markup language elements coordinates, however, when the elements are bulleted, SVG shape elements are arbitrarily selected to represent the icons.

Hypertext markup language elements mapped to equivalent SVG elements are shown in the following table. Not all hypertext markup language elements are mapped because needed information is gathered in other ways. When a hypertext markup language element only describes a style of the element contents, for example, a paragraph hypertext markup language tag, (<p>), mapping is not required because associated information is captured when a determination is made regarding the rendered style of the contents.

| HTML Element | SVG Element |
|---|---|
| div | g |
| span | g |
| A | link |
| Img | image |
| Table | g |
| Tr | g |
| Td | g |

All text on a page is a hypertext markup language text element. When the hypertext markup language document tree is traversed, elements, such as the paragraph tag, may be ignored; however, contents of a text node are still examined to calculate the rendered styles and position of the node. All hypertext markup language text nodes map to SVG text elements.

Process 500 determines whether more elements exist (step 514). When a determination is made that more elements exist, a “yes” result is obtained. When a determination is made that no more elements exist, a “no” result is obtained. When a “yes” result is obtained, process 500 loops back to step 510 to process a next element. When a “no” result is obtained, process 500 selects a predefined image type to create a selected image type (step 516). Process 500 generates the selected image type using equivalent SVG elements to form a generated image (step 518). Process 500 stores the generated image (step 520) and terminates thereafter (step 522). The stored image may be used in another process, such as an email distribution, or returned to a requester, wherein the requester can be a process or a user.

Thus is described in an illustrative embodiment, using JavaScript™ to traverse a rendered document object model in a hypertext markup language page and translation into an appropriate SVG extensible markup language of a SVG representation of a web page or portion of a web page into an image type. In one illustrative embodiment, a computer-implemented process for generating an image representing a page portion, the computer-implemented process receives a complex input to form a received input, renders the received input by a server based rendering engine to create a rendered virtual page and identifies elements of the virtual page to form identified elements. The computer-implemented process further translates each identified element into an equivalent scalable vector graphic element, generates an image using the equivalent scalable vector elements to form a generated image and stores the generated image.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for generating an image representing a page portion, the method comprising:
receiving a complex input to form a received input;
rendering the received input by a server based rendering engine to create a rendered virtual page;
identifying elements of the virtual page to form identified elements;
translating each identified element into an equivalent scalable vector graphic element;
generating an image using the equivalent scalable vector elements to form a generated image; and
storing, by a processor, the generated image.

2. The method as recited in claim 1, wherein the server based rendering engine is absent a browser and the rendered virtual page comprises a data structure in memory representing a document object model.

3. The method as recited in claim 1, wherein the identifying of elements of the virtual page to form identified elements further comprises:
traversing a document object model in a memory.

4. The method as recited in claim 1, wherein the translating of each identified element into the equivalent scalable vector graphic element further comprises:
storing the equivalent scalable vector graphic element to form a set of equivalent scalable vector graphic elements.

5. The method as recited in claim 4, wherein the storing of the equivalent scalable vector graphic element to form the set of equivalent scalable vector graphic elements further comprises:
determining whether more scalable vector graphic elements exist; and
responsive to a determination that more scalable vector graphic elements exist, returning to translate the each identified element into the equivalent scalable vector graphic element.

6. The method as recited in claim 1, wherein the generating of the image using the equivalent scalable vector elements to form the generated image further comprises:
selecting a predefined image type to create a selected image type.

7. The method as recited in claim 1, wherein the translating of each identified element into the equivalent scalable vector graphic element further comprises:
calculating a width and a height for the each identified element using an offsetWidth and offsetHeight property associated with the each element; and
calculating a Cartesian coordinate position for the each identified element by traversing the offsetWidth and offsetHeight property associated with a parent of the each element until a top element of a document object model is reached.

8. A computer program product embodied in a computer readable storage medium for generating an image representing a page portion, the computer program product comprising the programming instructions for:
receiving a complex input to form a received input;
rendering the received input by a server based rendering engine to create a rendered virtual page;
identifying elements of the virtual page to form identified elements;
translating each identified element into an equivalent scalable vector graphic element;
generating an image using the equivalent scalable vector elements to form a generated image; and
storing the generated image.

9. The computer program product as recited in claim 8, wherein the server based rendering engine is absent a browser and the rendered virtual page comprises a data structure in memory representing a document object model.

10. The computer program product as recited in claim 8, wherein the programming instructions for identifying elements of the virtual page to form identified elements further comprises the programming instructions for:
traversing a document object model in a memory.

11. The computer program product as recited in claim 8, wherein the programming instructions for translating each identified element into the equivalent scalable vector graphic element further comprises the programming instructions for:
storing the equivalent scalable vector graphic element to form a set of equivalent scalable vector graphic elements.

12. The computer program product as recited in claim 11, wherein the programming instructions for storing the equivalent scalable vector graphic element to form the set of equivalent scalable vector graphic elements further comprises the programming instructions for:
determining whether more scalable vector graphic elements exist; and
responsive to a determination that more scalable vector graphic elements exist, returning to translate the each identified element into the equivalent scalable vector graphic element.

13. The computer program product as recited in claim 8, wherein the programming instructions for generating the image using the equivalent scalable vector elements to form the generated image further comprises the programming instructions for:
selecting a predefined image type to create a selected image type.

14. The computer program product as recited in claim 8, wherein the programming instructions for translating each identified element into the equivalent scalable vector graphic element further comprises the programming instructions for:
calculating a width and a height for the each identified element using an offsetWidth and offsetHeight property associated with the each element; and
calculating a Cartesian coordinate position for the each identified element by traversing the offsetWidth and offsetHeight property associated with a parent of the each element until a top element of a document object model is reached.

15. A system, comprising:
a memory unit for storing a computer program for generating an image representing a page portion; and
a processor coupled to said memory unit, wherein said processor, responsive to said computer program, comprises:
circuitry for receiving a complex input to form a received input;
circuitry for rendering the received input by a server based rendering engine to create a rendered virtual page;
circuitry for identifying elements of the virtual page to form identified elements;
circuitry for translating each identified element into an equivalent scalable vector graphic element;
circuitry for generating an image using the equivalent scalable vector elements to form a generated image; and
circuitry for storing the generated image.

16. The system as recited in claim 15, wherein the server based rendering engine is absent a browser and the rendered virtual page comprises a data structure in memory representing a document object model.

17. The system as recited in claim 15, wherein the circuitry for identifying elements of the virtual page to form identified elements further comprises:
circuitry for traversing a document object model in a memory.

18. The system as recited in claim 15, wherein the circuitry for translating each identified element into the equivalent scalable vector graphic element further comprises:
circuitry for storing the equivalent scalable vector graphic element to form a set of equivalent scalable vector graphic elements.

19. The system as recited in claim 15, wherein the circuitry for generating the image using the equivalent scalable vector elements to form the generated image further comprises:
circuitry for selecting a predefined image type to create a selected image type.

20. The system as recited in claim 15, wherein the circuitry for translating each identified element into the equivalent scalable vector graphic element further comprises:
circuitry for calculating a width and a height for the each identified element using an offsetWidth and offsetHeight property associated with the each element; and
circuitry for calculating a Cartesian coordinate position for the each identified element by traversing the offsetWidth and offsetHeight property associated with a parent of the each element until a top element of a document object model is reached.
